(19) United States
(12) Patent Application Publication
(10) Pub. No.: US 2023/0349690 A1
(43) Pub. Date: Nov. 2, 2023

(54) Portable Device Comprising an Optical Depth Sensor

(71) Applicant: INUITIVE LTD., Ra’anana (IL)

(72) Inventor: Yishayahu SIEGAL, Rosh-HaAyin (IL)

(21) Appl. No.: 17/732,995

(22) Filed: Apr. 29, 2022

(51) Int. Cl. G01B 11/22; G06V 20/50; G08B 5/22

(52) U.S. Cl. CPC G01B 11/22; G06V 20/50; G08B 5/22

(57) ABSTRACT

A portable device configured to detect vertical changes in a surrounding of a moving person, wherein the portable device comprises: a housing; an optical depth sensor; a processor operative to: receive data from the depth sensor; process the data received; identify, based on the processed data, any vertical change that is present in the field of view of the optical depth sensor, and determine whether an identified vertical change forms a potential hazard to the moving person; and a warning generator for generating an indication to that person, upon determining that an identified vertical change forms a potential hazard to the moving person.

### TECHNICAL FIELD

The present disclosure generally relates to optical devices, and more particularly, to a device that comprises a depth sensor.

### BACKGROUND

For the blind or visually impaired people, the current state of technology, besides guide dogs, includes alternative devices most of which are based on mechanical designs (i.e., various types of canes and guide mechanisms) or ultra-sonic technologies. However, the available solutions do not overcome the problems which the blind and visually impaired people encounter.

Some attempts were made to improve the situation, for example by using ultrasound technology.

U.S. Pat. No. 6,469,956 discloses a solution that relies on scanning with an ultrasound wide beam the surrounding environment to detect obstacles. However, typical ultra-sonic devices that have been marketed are not reliable to provide a trusty solution for blind people to rely on the sensory detection signals. This solution does not allow easy finding of openings, especially from a distance. Wind and temperature changes affect the ultrasound beam and will give false distances. If approaching an obstacle at less than 45° degrees, the ultrasonic signal tends to miss the obstacle because it is reflected away from smooth surfaces.

US 20140251396 describes an electronic travel aid for visually impaired and blind people adapted to perform real-time navigation without digital camera and complex hardware. The electronic travel aid relates to real-time situations by utilizing speech messages stored in a flash memory for aiding the visually impaired or blind people.

U.S. Pat. No. 9,384,679 discloses a solution by which tactile feedback is provided to assist a visually impaired person in navigation and in avoiding collisions with objects. This solution relies on implementing a pressure pad which includes a plurality of pressure modules that provide a haptic response to the visually impaired person.

US 20160184169 describes a device for assisting a person in determining the presence of obstacles in the person's path. The device comprises a laser projector for generating a laser pattern comprising a plurality of laser lines on a surface in that person's path, a receiver for receiving images of the laser pattern reflected from the surface and a generator for generating a signal corresponding to the laser pattern reflection and a processor configured to process the signal in order to determine the presence of an object, and a generator for generating a warning to the user. The solution is based on distinguishing between one or more straight line segments in the laser pattern and distorted line segments of the laser pattern after their reflection from the surface and evaluating the distortions in the line segments of the laser pattern to determine the presence of an object in the user's path.

WO 2015131857 teaches the use of an apparatus for aiding vision combining a camera module and an optical sensor. According to this solution, when the optical sensor of the apparatus senses that the brightness of the ambient light is below a preset value, the indicator module is turned on to produce a flashing warning. When the light intensity reaches or exceeds a preset value, the indicator module is turned off, and the apparatus turns on the camera module to capture images of the road conditions. The processing chip also determines the position of an oncoming vehicle, calculates the approximate distance from that vehicle and on the basis of images captured by the camera module, generates a vibrating alert and voice warning so the user may avoid the oncoming vehicle.

However, apart from the fact that the solutions known in the art are far from being perfect, there is another problem associated with this matter, for which no solutions are known in the art. Namely, how to assist visually impaired people or blind people in avoiding scenarios where they can be injured while moving in a “monotonic colored.” environment, i.e., when approaching a staircase or when moving in a house having a low ceiling, especially under poor lighting conditions.

The present invention proposes a solution that deals with the above-described challenges.

### SUMMARY OF THE DISCLOSURE

The disclosure may be summarized by referring to the appended claims.

It is an object of the present disclosure to provide a device that enables the blind and the visually impaired persons to avoid obstacles that exist in their path, obstacles that are formed due to vertical changes that exist along the persons’ path.

It is another object of the present disclosure to provide a device that enables the visually impaired persons to avoid obstacles that exist in their path, when moving under poor illumination conditions.

It is another object of the present disclosure to provide a device that is capable of providing depth perception of the vicinity of blind and visually impaired users.

Other objects of the present invention will become apparent from the following description.

According to a first embodiment of the disclosure, there is provided a portable device configured to detect vertical changes in a surrounding of a moving person that might cause a potential hazard to blinds or visually impaired persons, wherein the portable device comprises:
a housing;
an optical depth sensor;
a processor operative to:
   receive data from the depth sensor;
   process the data received;
   identify, based on the processed data, vertical changes that are present in the field of view of the optical depth sensor, and determine whether any of the identified vertical changes forms a potential hazard to the moving person; and
a warning generator for generating an indication to that person, upon determining that an identified vertical change forms a potential hazard to the moving person

According to another embodiment of the disclosure the vertical change is a member selected from a group that consists of a staircase located along that person's path, a lowered ceiling, and the like.

In accordance with another embodiment of the disclosure the portable device is a member selected from among a group that consists of spectacles and an accessory, wherein the accessory is configured to be connected to any applicable handheld computing device such as a smartphone.

By yet another embodiment, the device is further configured to affect a change in operating parameters of the optical depth sensor, for example, by extending the area of detection i.e., by broadening the field of view of the optical depth sensor, or alternatively by increasing the distance between the user and the vertical change that can be identified. Optionally such changes in the operating parameters, are affected automatically upon determining by the processor that such a change is required in order to improve the portable device's operation. For example, when no changes are detected at the near vicinity of the user under previous operating parameters.

According to sill another embodiment of the disclosure, the portable device further comprises an illuminating module configured to illuminate an area determined by the processor as: a) an area associated with a vertical change that is suspected as a potential hazard to the moving person; or b) an area associated with a vertical change for which the processor is unable to reach a decisive determination whether that vertical change forms a potential hazard to the moving person, and wherein upon illuminating that area, the processor is further configured to re-assess whether the vertical change identified, forms a potential hazard to the moving person.

According to another embodiment of the disclosure, in case of poor light conditions, the illuminating module is configured to operate in accordance with at least one of the following:
i) to illuminate a whole field of view (FOV) associated with the optical depth sensor, until a sufficient information has been acquired by the optical depth sensor to enable the processor to determine whether the illuminated area includes a vertical change that forms a potential hazard to the moving person; and
ii) to illuminate a field of view (FOV) associated with the optical depth sensor with increasing intensity, until a sufficient information has been acquired by the optical depth sensor to enable the processor to determine whether the illuminated area includes a vertical change that forms a potential hazard to the moving person.

By still another embodiment, the device further comprises at least one image capturing module. Preferably, the processor is further operative to analyze data received from the at least one image capturing module.

In accordance with yet another embodiment of the disclosure, the processor is configured to illustrate for the user, the vertical changes that exist in his/her surrounding, based on the images' analysis made by the processor.

According to another embodiment, the processor is further configured to identify all objects included within the field of view of the optical depth sensor and the warning generator is further configured to generate an indication, upon detection of every object identified within the field of view of the optical depth sensor.

### BRIEF DESCRIPTION OF THE DRAWINGS

For a more complete understanding of the present invention, reference is now made to the following detailed description taken in conjunction with the accompanying drawing wherein:
FIG. 1—illustrates a schematic representation of a portable device construed in accordance with an embodiment of the present invention.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

In the following description, for the purposes of explanation, numerous specific details are set forth in order to provide a better understanding of the present invention by way of examples. It should be apparent, however, that the present invention may be practiced without these specific details.

As explained above, the present disclosure relates to an effective portable device for eliminating or at least substantially reducing the risks for the blinds and visually impaired persons to encounter an obstacle which is formed due to a vertical change that exists in the path along which they move, such an obstacle may be for example a stair/stair case located along that person's path, a lowered ceiling and the like.

One of the fundamental principles that the present invention relies on is the use of a depth sensor such as an optical depth sensor. In the alternative, different types of modules can be used to provide depth sensing information such as stereo cameras, sonar, Time of Flight (TOF) module, radar, lidar and the like.

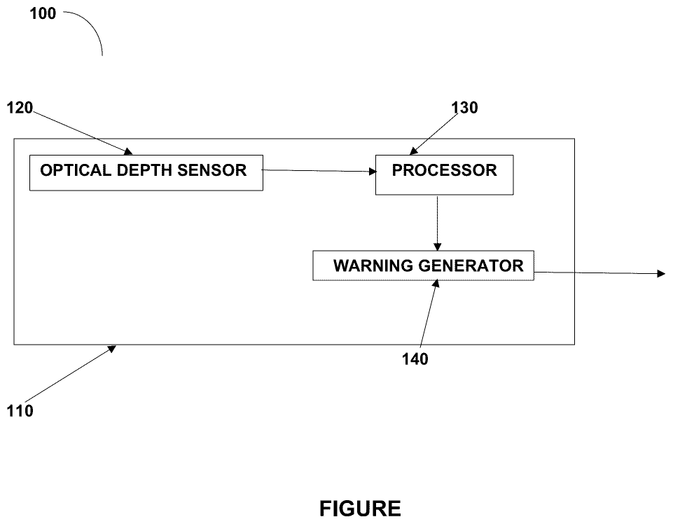

FIG. 1 illustrates a schematic representation of a portable device construed in accordance with an embodiment of the present invention.

The portable device 100 which may be for example a wearable device such as spectacles, headset earphones or be implemented in any other applicable form. In the alternative the device may be a handheld accessory that is connected to a computing device such as a smartphone, PDA, etc.

Portable device 100 comprises a housing 110, a depth sensor 120 which in this example is an optical depth sensor capable of detecting vertical changes in the surrounding of the moving person, a processor 130 and a warning generator 140.

Processor 130 is operative to: receive data from the depth sensor which relates to all targets comprised within the field of view of the optical depth sensor. The data received includes data that relates to vertical changes that are present in the current field of view. Processor 130 processes the received data and determines, based on the processed data, whether any of the vertical changes detected within the field of view of the optical depth sensor, forms a potential hazard to the moving person.

Once processor 130 determines that there is a potential hazard to the moving person from a vertical change detected, it forwards a signal to warning generator 140, so that the latter can generate an indication for that person, notifying that there is a hazard nearby. The indication may be in the form of a series of beeps (preferably, at an increasing intensity along with the approaching of the person to the detected obstacle). Alternatively, the indication may be in the form of a vibration that is felt by the user. Here again, the indication (vibration) is preferably at an increasing intensity along with the approach of the person to the detected obstacle.

Although the present disclosure is directed primarily to the identification of vertical changes that are present within the FOV of the optical depth sensor, still, according to another embodiment of the present disclosure, the very same device is also used to provide an indication to the user when other objects that are present within the FOV, are detected.

According to another embodiment of the present disclosure, the portable device 100 further comprises an image capturing module (not shown in this FIG.). By this embodiment, processor 130 is further operative to analyze data received from the image capturing module and to form an illustration for the visually impaired person of the vertical change that exists in his/her surrounding, based on the analysis of the captured images, as made by processor 130.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A portable device configured to detect vertical changes in a surrounding of a moving person, wherein said portable device comprises:
a housing;
an optical depth sensor comprising two stereo cameras, wherein said stereo cameras are configured to acquire a plurality of objects included within the field of view of said optical depth sensor;
a processor operative to:
receive data from said optical depth sensor that relate to the plurality of objects included within the field of view of said optical depth sensor acquired by said two stereo cameras;
process the data received from said two stereo cameras and combine them into a single image representing the field of view of the optical depth sensor;
identify, based on the image obtained from the processed data, vertical changes that are present within the field of view of the optical depth sensor, and determine whether any identified vertical change forms a potential hazard to the moving person; and
a warning generator for generating an indication to said person, upon determining that an identified vertical change forms a potential hazard to the moving person.

2. The portable device of claim 1, wherein said vertical change is a member selected from a group that consists of a stair located along that person's path and a lowered ceiling.

3. The portable device of claim 1, wherein said device is a member selected from among a group that consists of spectacles and an accessory, wherein said accessory is configured to be connected to a handheld computing device.

4. The portable device of claim 1, wherein said device is further configured to affect a change in operating parameters of the optical depth sensor operation.

5. The portable device of claim 1, further comprising an illuminating module configured to illuminate an area determined by the processor as: a) an area associated with a vertical change that is suspected as a potential hazard to the moving person; orb) an area associated with a vertical change for which the processor is unable to reach a decisive determination whether that vertical change forms a potential hazard to the moving person, and wherein upon illuminating said area, the processor is further configured to re-assess whether the vertical change detected, does form a potential hazard to the moving person.

6. The portable device of claim 5, wherein in case of poor light conditions, the illuminating module is configured to operate in accordance with at least one of the following:
i) to illuminate a whole field of view (FOV) associated with the optical depth sensor, until a sufficient information has been acquired by the optical depth sensor to enable the processor to determine whether the illuminated area includes a vertical change that forms a potential hazard to the moving person; and
ii) to illuminate a field of view (FOV) associated with the optical depth sensor with increasing intensity, until a sufficient information has been acquired by the optical depth sensor to enable the processor to determine whether the illuminated area includes a vertical change that forms a potential hazard to the moving person.

7. The portable device of claim 1, wherein said device further comprises at least one image capturing module.

8. The portable device of claim 7, wherein said processor is further operative to analyze data received from the at least one image capturing module.

9. The portable device of claim 8, wherein said processor is configured to illustrate the vertical changes that exist in a surrounding of a moving person, based on the images' analysis made by the processor.

10. The portable device of claim 1, wherein said processor is further configured to identify all objects included within the field of view of the optical depth sensor and the warning generator is further configured in generate an indication upon detection of an object identified within the field of view of the optical depth sensor.
